(19) United States
(12) Patent Application Publication
(10) Pub. No.: US 2024/0254361 A1
(43) Pub. Date: Aug. 1, 2024

(54) A HIGH PERFORMANCE ISOCYANATE FREE POLYURETHANE RESIN COATING

(71) Applicant: A & I Coatings Group Pty Ltd, Moss Vale, NSW (AU)

(72) Inventors: Fu Rong JIANG, Moss Vale (AU); Stephen BAILEY, Moss Vale (AU)

(73) Assignee: A & I Coatings Group Pty Ltd, Moss Vale, NSW (AU)

(21) Appl. No.: 18/558,446

(22) PCT Filed: Aug. 16, 2022
(86) PCT No.: PCT/AU2022/050906

§ 371 Date: Nov. 1, 2023

(30) Foreign Application Priority Data
Aug. 16, 2021 (AU) 2021218019
Jun. 20, 2022 (AU) 2022204302

(51) Int. Cl. C09D 175/12; C08G 18/20; C08G 18/22; C08G 18/24; C08G 18/71; C08G 18/83; C09D 5/08

(52) U.S. Cl. CPC C09D 175/12; C08G 18/2063; C08G 18/222; C08G 18/227; C08G 18/24; C08G 18/718; C08G 18/837; C09D 5/08

(57) ABSTRACT

A method of preparing a high performance low isocyanate polyurethane top coating effective to protect external architectural surfaces and substantially minimizing applicator exposure to isocyanates, including: providing an amount of compound A chosen from a fluoroethylene vinyl ether (FEVE) moiety of formula (I); providing an amount of Compound B chosen from a silane functional isocyanate of general formula (II); where compound A and compound B are present in a stoichiometric ratio of 1:1; providing an effective amount of a catalyst of compound C; introducing compounds A and B into a reaction vessel and stirring the compounds in an inert atmosphere at a predetermined temperature and a predetermined time; where the resultant silane functional FEVE resin is substantially free of unreacted isocyanate.

### FIELD

The present invention relates to a high-performance isocyanate free polyurethane resin coating.

In particular, the present invention relates to a high-performance silane-functional polyurethane resins, which substantially minimizes the use of and exposure to isocyanates and provides high performance and durability.

The invention has been developed primarily for use in minimizing isocyanate exposure while improving coating effectiveness and durability in relation to a wide range of structures and substrates and will be described hereinafter with reference to this application. However, it will be appreciated that the invention is not limited to this particular field of use.

### BACKGROUND

Public infrastructure such as outdoor buildings, bridges, machines, vehicles, boats, planes, furniture, floors, glasses, plastics and the like, made from architectural materials, metal, concrete, plastic and wood substrates, require surface protection to prolong service life. Such substrates when exposed to weather and elements may deteriorate and require replacement or upgrades or frequent overhaul to maintain usefulness and structural integrity.

Polyurethane resins were first produced and applied to substrates as protective topcoats due to their high resistance to weathering, solvents, and mechanical damage.

Polyurethanes used in coatings are usually divided into single (1 K) or two-component (2 K) products. The single component polyurethane coatings are generally produced from a stable mixture of polyisocyanate and polyol components. The more widely used two-component polyurethanes comprise two reagents stored separately in the form of a mixture of macromolecular compounds containing hydroxyl groups (polyol), catalysts and additives (component 1), and hardener (component 2), in the form of polyisocyanate resin solutions. Cross linking (curing) starts as soon as components 1 and 2 are mixed. The isocyanates used are primarily aromatic including toluene diisocyanate or methylene diphenyl 4,4′-diisocyanate but can include aliphatic diisocyanates such as Hexamethylene diisocyanate which are known skin and respiratory tract irritants and may cause sensitization with repeated exposure.

While the resulting polyurethane network offers the advantage of high chemical stability and protection against weathering and degradation of substrates, the life cycle of polyurethane top coatings is limited with loss of significant color and gloss, and touch-ups and re-coats are required due to spot corrosion. In addition, frequently used isocyanates are classified as carcinogenic, mutagenic and generally toxic substances and exposure to unreacted isocyanates represents a substantial health risk potentially disposing an applicator to long term or permanent respiratory problems. To this extent that this is a problem, in August 2020 the European Council concerning the Registration, Evaluation, Authorisation and Restriction Chemicals (REACH) amended Annex XVII to Regulation (EC) No. 1907/2006 to restrict the cumulative concentration of diisocyanates in a manufactured or imported substance to less than 0.1% by weight.

Some attempts have been made to develop compositions that can be used as highly durable protective coatings of architectural applications intended for exterior use to reduce adverse health effects, adverse environmental effects, and re-coating costs and associated labour costs. Fluorine substituted polymeric materials have been used as binders in coatings. Such coatings are known to exhibit low surface energies, insulating properties, impermeability to gases, and high resistance to water, oils, chemicals, corrosion dirt pickups, UV radiation, chalking.

Use of fluoropolymers in coatings is however limited due to their physical properties. Fluoropolymers have poor solubility in traditional solvents used in the coating industry. Usually, fluoropolymer resins must be heated to temperatures greater than 200 degrees ° C. to form a coating. In addition, the low surface energy of the resins impedes acceptable adhesion to metals and other substrates.

Other attempts to reduce exposure of an applicator to unreacted isocyanates have utilized alternative chemistries to achieve a polyurethane network. Some research on cyclic carbamates have found that aliphatic polyurethane can be achieved by reacting a cyclic carbamate with a polyamine, eliminating the potential of isocyanate exposure to an applicator. A particular drawback with this approach is the complete overhaul of chemistry and starting materials which result in a network without the positive attributes associated with properties of a standard polyurethane system.

Therefore, there is still a need to develop a practical system or process to provide high quality coating qualities of a polyurethane while reducing isocyanate exposure to an applicator.

The present invention seeks to provide a practical system or process to synthesize a top coating for practical use, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY

The present invention in a first aspect is directed to a formulation for preparing a high-performance polyurethane top coating effective to protect external surfaces and substantially minimizing applicator exposure to isocyanates, comprising: compound A chosen from a fluoroethylene vinyl ether (FEVE) moiety of formula

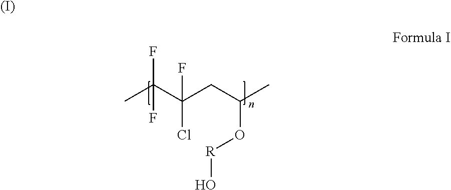

wherein
n is an integer higher than or equal to 1, in particular 1 to 10,
R is CH₂ or a linear or branched hydrocarbon chain; and
Compound B chosen from a silane functional isocyanate of general formula (II):

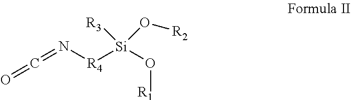

where R₁, R₂ and R₄ can be a linear or branched hydrocarbon chain, aryl;
   and R₃ can be H, OCH₃, O(CH₂)ₙCH₃ where n can be at least 1 to 5.

The formulation of the present invention includes characteristics of improved UV-resistance coupled with improved environmental and applicator friendly curing mechanism using silane functionality. Advantageously, the formulation can produce a high-performance top coating having substantially no measurable quantity of unreacted isocyanate compared to conventional polyurethane resins, which could expose an applicator to deleterious health effects when applying the topcoat to a substrate.

Preferably, the formulation includes compound A and compound B present in a stoichiometric ratio of 1:1 (relative to hydroxyl equivalent weight of compound A).

Preferably, the formulation further includes a catalyst (compound C) effective to catalyse reaction between compound A and compound B at ambient temperature. This overcomes prior art requirements of heating to form a coating.

Preferably, the catalyst can be selected from bismuth chelate, Aluminium chelate, Tin chelate, Zinc chelate, zinc complex, and base catalyst including 1,4-diazabicyclo[2.2.2]octane. Most preferably the catalyst is bismuth carboxylate.

Reaction between compound A and compound B in the presence of a catalyst is found to produce a silane functional polyurethane resin according to a compound of formula (III).

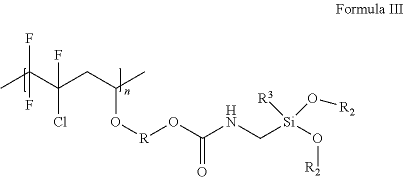

wherein
n is an integer higher than or equal to 1, in particular 1 to 10, and
   wherein conversion to formula (III) is substantially complete with minimal or indeed undetected presence of unreacted isocyanate by Fourier Transform Infrared spectroscopy within about 72 hours. This unexpected high rate of conversion which can be determined by using Fourier Transform Infrared spectroscopy, confirms the presence of no unreacted isocyanates. This represents a significant departure from and advantage over prior art polyurethane systems.

In a related aspect, the invention there is directed to a formulation for preparing a high-performance resin coating effective to protect external surfaces and substantially minimizing applicator exposure to isocyanates, comprising: compound A chosen from a fluoroethylene vinyl ether (FEVE) moiety of formula (I):

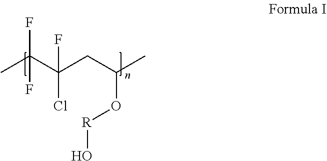

wherein
n is an integer higher than or equal to 1, in particular 1 to 10,
R is a linear or branched hydrocarbon chain,
Compound B chosen from a silane functional isocyanate of general formula (XX):

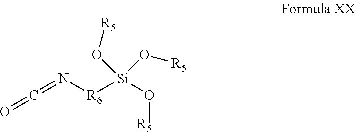

wherein R₅ is CH₃, (CH₂)ₙCH₃ where n can be at least 1 to 5, wherein the three alkoxy groups in the compound of formula XX can be the same or different from one another, and
wherein R₆ can be CH₃, (CH₂)ₙCH₃ where n can be at least 1 to 5,
In one embodiment, compound A of Formula (I) is a FEVE moiety in which R is CH₂ and n=1 or more, and compound B of Formula (XX) is 3-isocyanatopropyltriethoxy silane shown below.

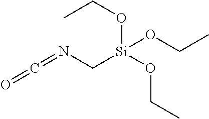

Reaction between compound A and compound B in the presence of a catalyst is found to produce a silane functional polyurethane resin according to a compound of formula (III).

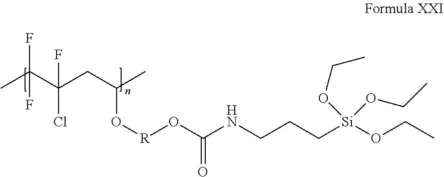

Conversion to formula (XXI) is substantially complete with minimal or indeed undetected presence of unreacted isocyanate by Fourier Transform Infrared spectroscopy within about 72 hours. This unexpected high rate of conversion which can be determined by using Fourier Transform Infrared spectroscopy, confirms the presence of no unreacted isocyanates. This represents a significant departure from and advantage over prior art polyurethane systems.

In a further related aspect of the present invention, there is described a formulation for producing a silane functionalized FEVE resin as an improved top coat for architectural materials comprising: compound A of formula (I) and compound B of formula (II) present in a stoichiometric ratio of 1:1; an effective catalytic amount of bismuth carboxylate; wherein compound A and compound B are reacted in the presence of the catalyst for a predetermined period of time at ambient temperature or above to produce the silane functionalized FEVE resin having substantially no unreacted isocyanate determined by Fourier Transform Infrared spectroscopy analysis.

The silane functionalized reaction product of a compound of formula (I) and formula (II) is a resin which incorporates physical benefits of fluoropolymers including high UV resistance, high scratch resistance and weatherability of polyurethanes, without the adverse environmental effects and exposure of an applicator to unreacted isocyanate.

A further advantage of silane functionalized reaction products in accordance with the invention, is that a top coating can be applied directly to a substrate material as opposed to requiring multiple primer coats to improve adhesive strength of a polyurethane topcoat.

The present formulation of the invention can include Compound D of formula (IV). Compound D is an acrylic polyol which can be substituted for Compound A, which reacts with silane isocyanate cross linker Compound B.

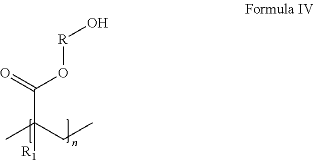

wherein
n is an integer higher than or equal to 1, in particular 1 to 10,
R₁ is H or CH₃,
R is a linear or branched hydrocarbon chain,

Reaction between compound B of general formula (XX) and compound D of formula (IV) produces a silane functional acrylic polyurethane resin according to a compound of formula (V).

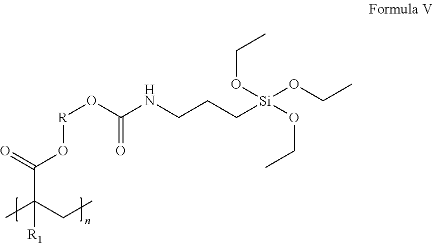

wherein
n is an integer higher than or equal to 1, in particular 1 to 10,
R₁ is H or CH₃,
R is a linear or branched hydrocarbon chain,

In a related embodiment, the present formulation of the invention can include Compound E of formula (VI). Compound E is a polyether polyol which can be substituted for Compound A, which reacts with silane isocyanate cross linker Compound B.

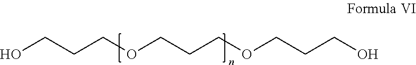

In a related embodiment, the present formulation of the invention can include Compound F of formula (VII). Compound F is a polyester polyol which can be substituted for Compound A, which reacts with silane isocyanate cross linker Compound B.

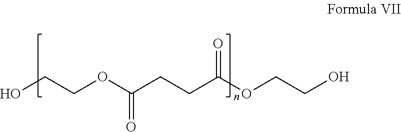

In yet a further related embodiment, the present formulation of the invention can include Compound G of formula (VIII). Compound G is a polybutadiene polyol which can be substituted for Compound A, which reacts with silane isocyanate cross linker Compound B.

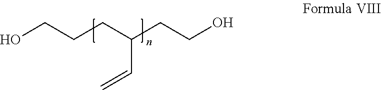

In still a further related embodiment, the pres Formula VIII I of the invention can include Compound H of formula (IX). Compound H is a polycarbonate polyol which can be substituted for Compound A, which reacts with silane isocyanate cross linker Compound B.

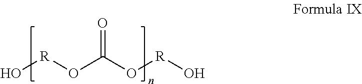

Each polyol type including compounds E to H have varying properties such as polarity, flexibility and hydroxyl equivalent weight, which applicants have found produce unique resin systems which have consumer benefits.

In a related aspect of the invention there is described a method of preparing a high performance top coating effective to protect external architectural surfaces and substantially minimizing applicator exposure to isocyanates, comprising: introducing a predetermined amount of compound A chosen from a fluoroethylene vinyl ether (FEVE) moiety of formula (I) and compound B chosen from a silane functional isocyanate of general formula (II), in a stochiometric ratio of 1:1, into a reaction vessel; providing an effective amount of a catalyst of compound C; stirring the reactants in an inert atmosphere at a predetermined temperature for a predetermined time; wherein the resultant silane functional FEVE resin is substantially free of unreacted isocyanate.

Preferably, the inert atmosphere is provided by nitrogen.

Preferably, the temperature of the reaction between compounds A and B in the presence of catalyst compound C is ambient temperature (15 degrees C.) to about 80 degrees ° C.

Preferably, the compounds A and B are subject to stirring for between about 12 hours to 72 hours.

Preferably, the catalyst is bismuth carboxylate present in the reaction in an amount of between about 0.4% w/w to about 20% w/w.

In a further related aspect, the invention there is directed to a formulation for preparing a high-performance resin coating effective to protect external surfaces and substantially minimizing applicator exposure to isocyanates, comprising: compound I chosen from an aspartic ester moiety of formula (X):

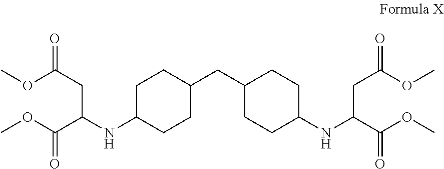

and Compound B chosen from a silane functional isocyanate of general formula (II).

Reaction between compound I and compound B in the presence of a catalyst is found to produce a silane-cure polyaspartic resin according to a compound of formula (XI).

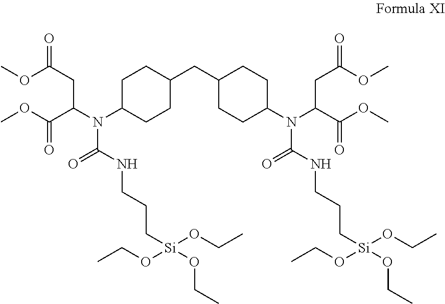 [SMILES: CCO[Si](CCCNC(=O)N(C1CCC(CC2CCC(N(C(=O)NCCC[Si](OCC)(OCC)OCC)C(CC(=O)OC)C(=O)OC)CC2)CC1)C(CC(=O)OC)C(=O)OC)(OCC)OCC]

Polyaspartic esters which are traditionally used to generate polyaspartic coatings utilizing the urea formation, were designed with bulky substituents so as to reduce the reaction rate attributed to polyurea, thereby to slow the curing process making them more usable in spray equipment. The use of a compound of formula II to generate a silane-cure polyaspartic resin of formula XI allows the use of conventional polyamines, which would be far too reactive under normal isocyanate cure conditions, to be used. Therefore, in yet a further related aspect of the present invention there is described a formulation for preparing a high-performance resin coating effective to protect external surfaces and substantially minimizing applicator exposure to isocyanates, comprising: compound J chosen from a polyamine moiety of formula (XII):

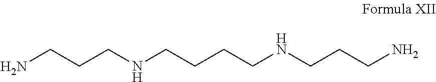 [SMILES: NCCCNCCCCNCCCN]

and Compound B chosen from a silane functional isocyanate of general formula (II).

Reaction between compound J and compound B in the presence of a catalyst is found to produce a silane-cure polyamine resin such as a highly reactive tetraamine according to a compound of formula (XIII).

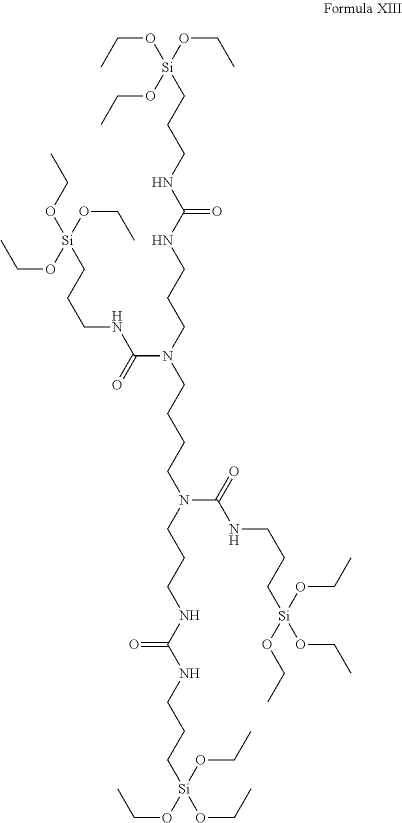 [SMILES: CCO[Si](CCCNC(=O)NCCCN(CCCCN(CCCNC(=O)NCCC[Si](OCC)(OCC)OCC)C(=O)NCCC[Si](OCC)(OCC)OCC)C(=O)NCCC[Si](OCC)(OCC)OCC)(OCC)OCC]

Benefits of the invention include:
Minimizes and substantially eliminates unreacted isocyanates in producing silane functionalized FEVE resin;
A high conversion rate to the silane functionalized FEVE resin is achieved. As a result, toxic environmental exposure of an applicator to unreacted isocyanates is substantially eliminated;
The physical properties of the resulting silane functionalized FEVE resin retains properties of a polyurethane coating in addition to high UV resistance properties of a fluoropolymer.
Minimizes and substantially eliminates unreacted isocyanates in producing silane functionalized acrylic polyurethane resin;

Problems of prior art coating formulations requiring heating before application is overcome.

The resulting silane functionalized FEVE resin product and silane functionalized acrylic polyurethane resin improves adhesion to architectural material substrates hence reduced need for primer coats.

Other aspects of the invention are also disclosed with reference to accompanying examples.

### EXAMPLES

Notwithstanding any other forms which may fall within the scope of the present invention, preferred embodiments of the invention will now be described, by way of example only, in which:

### Example 1: Silane Functionalized FEVE Resin with Non-Detectable Isocyanate

### Introduction

Polyurethane (PU) coatings are generally considered to provide reasonable protection against weathering and degradation. However PU coatings suffer from relatively low resistance to UV radiation and are known to expose an applicator to very undesirable toxic health effects due to unreacted isocyanate.

### Study Design

A range of silane functionalized FEVE resins have been prepared to assess ability to perform as a top coating and substantially eliminate unreacted isocyanates.

### Study Protocols

Rate of conversion of reactants from Compound A of formula (I) and Compound B of formula (II) was tracked using Fourier Transform Infrared spectroscopy (FT-IR). In this way, the presence of any unreacted isocyanate could be determined.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is an FT-IR spectra of a compound B of formula (II) showing characteristic isocyanate peak at about 2300 cm⁻¹;

FIG. 2 is an FT-IR spectra of a FEVE polyol resin according to compound A of formula (I);

FIG. 3 is an FT-IR spectra of a reaction at time 0 hours between FEVE polyol resin according to compound A of formula (I) and a compound B of formula (II);

FIG. 4 is an FT-IR spectra of a reaction progress at time 12 hours between FEVE polyol resin according to compound A of formula (I) and a compound B of formula (II);

FIG. 5 is an FT-IR spectra of a reaction progress at time 48 hours between FEVE polyol resin according to compound A of formula (I) and a compound B of formula (II);

FIG. 6 is an FT-IR spectra showing combined reaction progress at times 0, 12 and 48 hours between FEVE polyol resin according to compound A of formula (I) and a compound B of formula (II);

FIG. 7 shows testing of the formulated silane-cure FEVE polyurethane

FIG. 8 is an FT-IR spectrum of commercially available polyisocyanate Edolan XCI;

FIG. 9 is an FT-IR spectrum of commercially available polyisocyanate HDI trimer Desmodur N3800;

FIG. 10 is an FT-IR spectrum of commercially available polyisocyanate HDI trimer Tolonate XF 800;

FIG. 11 is an FT-IR spectra of an aliphatic polyol A showing hydroxyl and carbonyl functionality;

FIG. 12 is an FT-IR spectrum of isocyanate B showing isocyanate functionality;

FIG. 13 is an FT-IR spectra of the reaction mixture of polyol A and isocyanate B to form silane modified isocyanate free resin C with in-built urethane functionality (2 hours after initial mixing);

FIG. 14 is an FT-IR spectra of the reaction mixture of polyol A and isocyanate B to form resin C with in-built urethane functionality (24 hours after initial mixing);

FIG. 15 is an FT-IR spectra of the reaction mixture of polyol A and isocyanate B to form resin C with in-built urethane functionality (72 hours after initial mixing);

FIG. 16 is a combined FT-IR spectra of the reaction to produce resin C with in-built urethane functionality;

FIG. 17 is an FT-IR analysis of the pack A of Weathermax HBR high build polyurethane (Dulux) indicating the presence of polyol and carbonyl functionality

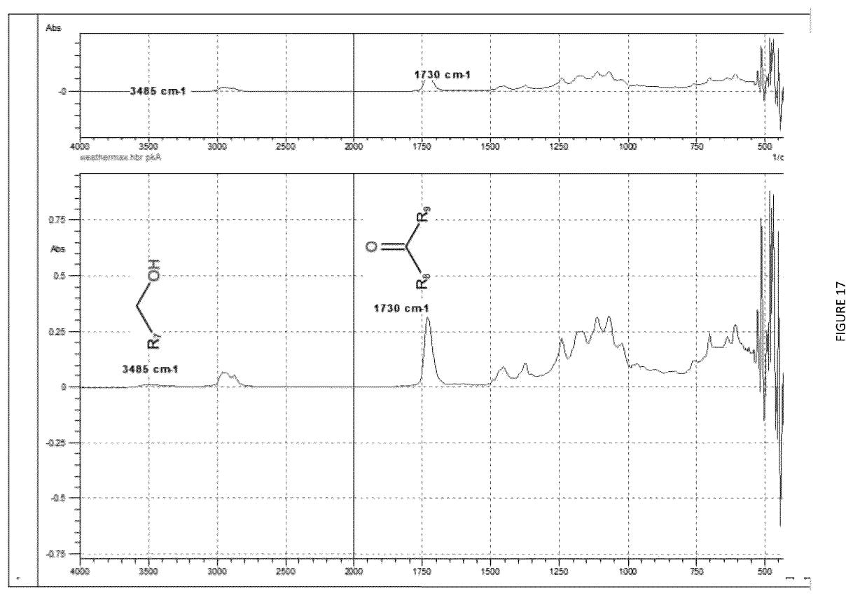

FIG. 18 is an FT-IR analysis of the pack B of Weathermax HBR high build polyurethane (Dulux) indicating the presence of isocyanate and carbonyl functionality;

FIG. 19 is an FT-IR analysis of the pack A of silane modified isocyanate-free polyurethane of the invention indicating the presence of carbonyl and urethane functionality; and

FIG. 20 is an FT-IR analysis of the pack B of silane modified isocyanate-free polyurethane indicating the presence of amine and carbonyl functionality.

### DETAILED DESCRIPTION OF THE EMBODIMENTS

In a first protocol (see reaction sequence below), an amount of a FEVE moiety (8) according to compound A of formula (I) was reacted with an amount of a silane functional isocyanate (SFI) (10) according to compound B of formula (XX), preferably being 3-(triethoxysilyl)propyl isocyanate, in a stoichiometric ratio of 1:1 to produce silane functional FEVE resin (11) of formula (XXI).

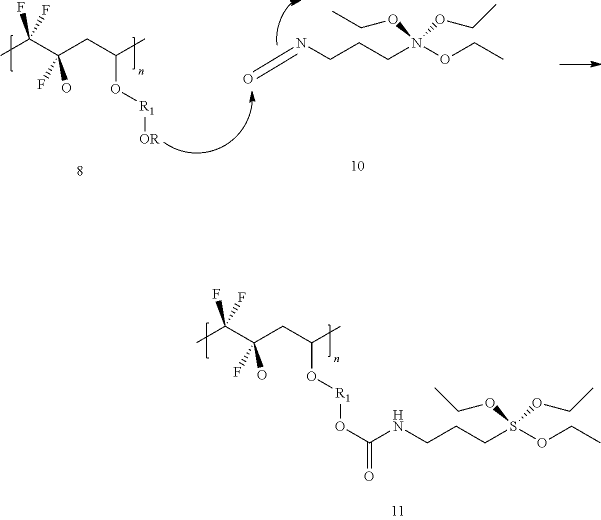

A range of temperatures were used with and without a catalyst. Reactants were stirred continuously in an inert nitrogen atmosphere for a range of time periods, and conversion of reactant crosslinker (10) with time observed to completion. Table 1 (below) shows results of the first protocol.

Table 1 shows overall results of a range of reactants, catalyst, conditions, catalyst loading and conversion.

TABLE 1
conversions

| | | | | | | Conversion |
|---|---|---|---|---|---|---|
| | | | | | | to Silane |
| | | | | | Catalyst | functional |
| | | | | | loading % | FEVE resin |
| | | | temperature | | (w/w) of | (11) |
| Test | polyol | crosslinker | (° C.) | catalyst | SFI (10) | (hours) |
| 1 | FEVE (8) | SFI (10)* | 45 | DABCO | 1.5 | 48 |
| 2 | FEVE (8) | SFI (10) | 45 | Aluminium | 1.5 | 72 |
| | | | | chelate | | |
| 3 | FEVE (8) | SFI (10) | 45 | Zirconium | 1.5 | 72 |
| | | | | chelate | | |
| 4 | FEVE (8) | SFI (10) | 45 | Zinc | 1.5 | 72 |
| | | | | complex | | |
| 5 | FEVE (8) | SFI (10) | 15 | Tin chelate | 1.5 | 36 |
| 6 | FEVE (8) | SFI (10) | 45 | Titanium | 1.5 | 72 |
| | | | | complex | | |
| 7 | FEVE (8) | SFI (10) | 15 | Bismuth | 1.5 | 36 |
| | | | | chelate | | |
| 8 | FEVE (8) | SFI (10) | 15 | Bismuth | 2.3 | 12 |
| | | | | chelate | | |
| 9 | FEVE (8) | SFI (10) | 15 | Bismuth | 0.8 | 72 |
| | | | | chelate | | |
| 10 | FEVE (8) | SFI (10) | 15 | Bismuth | 0.4 | >72 |
| | | | | chelate | | |

*SFI (10)—silane functional isocyanate (10)

In a further example, a silane functionalized FEVE resin (11) of formula (XXI) was synthesized by reacting a predetermined amount of: (i) a FEVE moiety (8) of formula (I), and (ii) a silane functional isocyanate (10) of formula (XX) in the presence of an inert atmosphere of nitrogen; wherein compounds 8 and 10 were present in a stoichiometric ratio of 1:1.

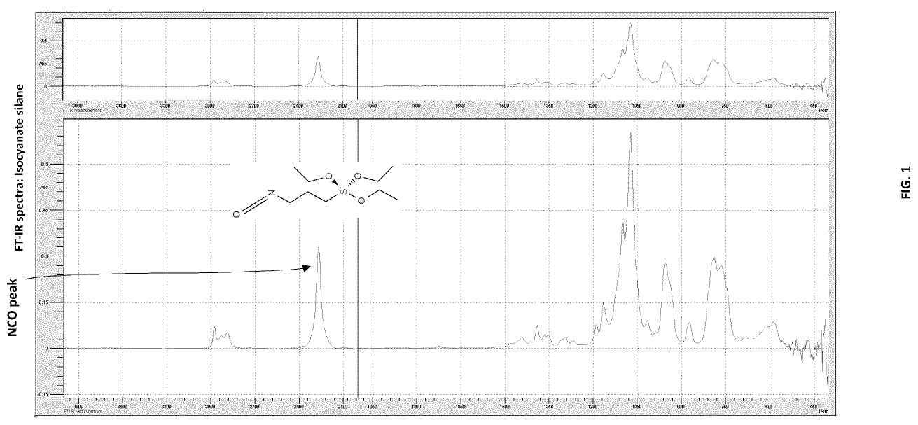

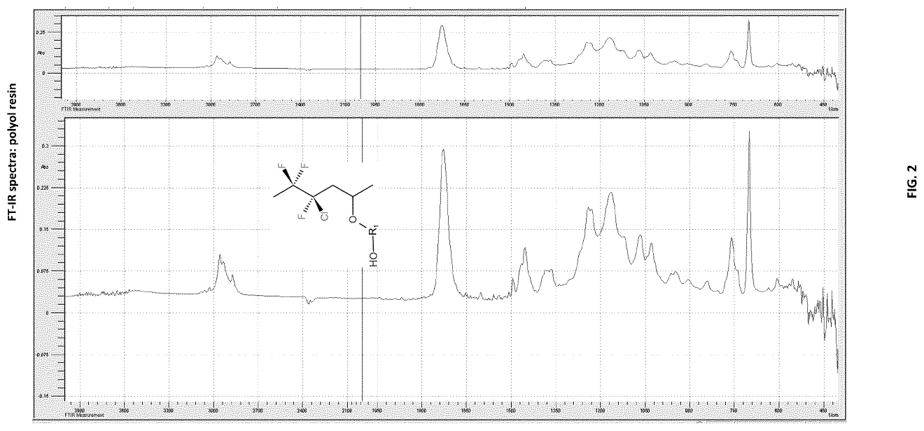

In one test reaction, an amount of bismuth carboxylate catalyst was present in an amount of 0.4% w/w of silane functional isocyanate (10), and the reactants thereafter subject to stirring at a temperature of 15 degrees ° C. for a period of 48 hours. The reaction was monitored via Fourier-transform infrared spectroscopy (FT-IR) for the consumption of (10), which could be identified via the diagnostic NCO peak at around 2300 cm⁻¹. FIG. 1 shows show a characteristic isocyanate peak at 2300 cm⁻¹, and FIG. 2 shows spectra for a FEVE moiety (8) according to formula (I).

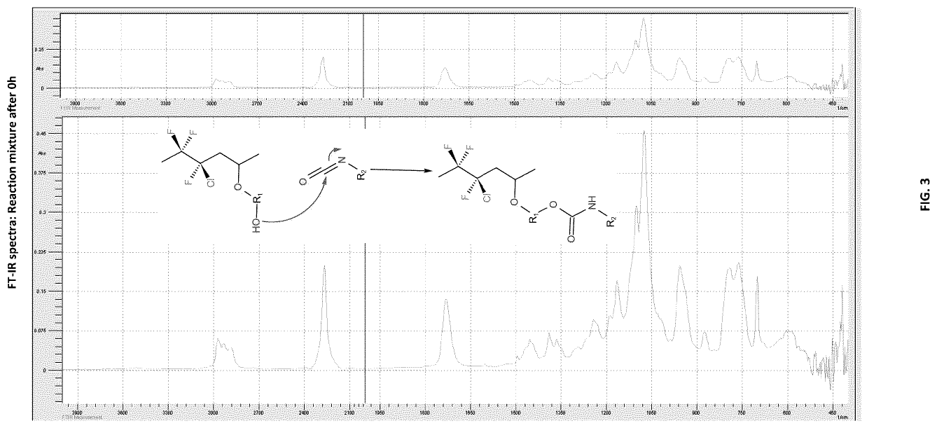

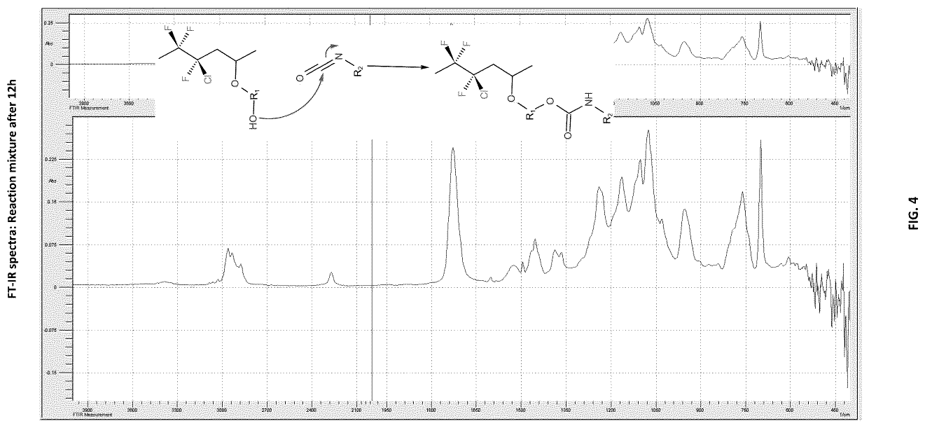

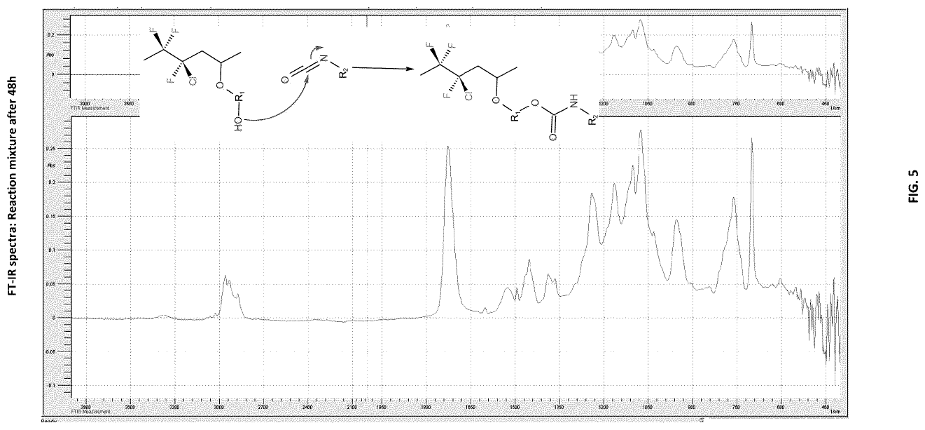

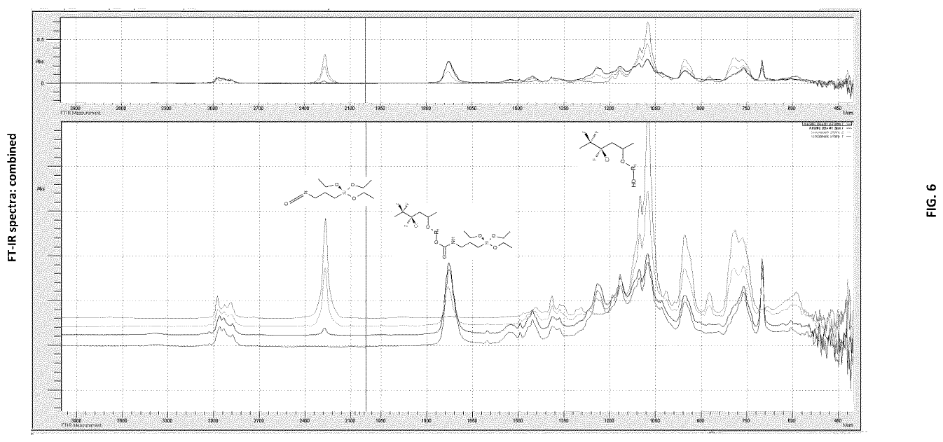

The progress of reaction was monitored by FT-IR for the consumption of silane functional isocyanate of formula (XX) in FIGS. 3 to 6. Between intervals at 0, 12 and 48 hours, FTIR spectra shows progressive conversion of the isocyanate functionality to an extent where, as can be seen in FIG. 6, the characteristic isocyanate peak is not present indicating no unreacted isocyanate. This represents a significant departure from prior art coatings.

While compound 8 of general formula XX was ostensibly used and found to generate stable silane-resin systems substantially without compromising the reactivity and cure speed of the coating, several alternative isocyanate silane compounds were tested, which have beneficial properties to the final coating system. For example, alternative isocyanate silane compounds can include the following:

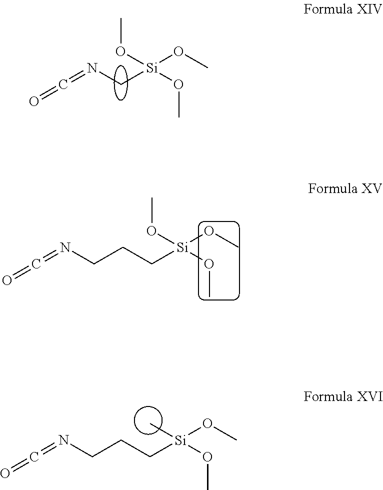

Tests show that decreasing the carbon chain of the isocyanate silane as in formula XIV has the effect of decreasing hydrophobic properties of the generated silane-resin and removing ethylene group from formula II reduces molecular weight of the resin.

The proposed isocyanate silane of formula XV shows substitution of tri ethoxy to tri methoxy increases the rate of hydrolysis and subsequent rate of cure, however the resulting resin is likely to be a less stable silane resin.

With reference to formula XVI, there is shown a decrease of the silane content of the isocyanate silane. The concomitant effect on the resultant silane resin is a decrease in polysiloxane-type properties, lower network density and improved chain movement and flexibility.

The reaction procedure was also found to be robust with aliphatic acrylic polyols according to formula IV Cray Valley Synocure 854 BA 80 (18) and Nuplex Setalux DA 870 BA (19) producing the silane functional equivalents within 72 h, and the aspartic ester diamine Covestro Desmophen 1420 (20), at 15 degrees C. and in the presence of Bismuth chelate catalyst (17) producing the silanated analogue within 24 hours.

Tests results of silane functionalization of polyol and aspartic ester resins 18, 19 and 20 shown in Table 2 below:

TABLE 2
silane functionalization of polyol and aspartic ester resins 18,
19 and 20

| | | | | Complete |
|---|---|---|---|---|
| | | | | conversion |
| | | | | to |
| | | | | silane-cure |
| | | | | resin |
| entry | resin | crosslinker | conditions | (FT-IR) |
| 1 | FEVE polyol 8 | SFI (10) | 15° C., catalyst 17 0.8% | 72 h |
| | | | (w/w) | |
| 2 | Acrylic polyol 18 | SFI (10) | 15° C., catalyst 17 0.8% | 72 h |
| | | | (w/w) | |
| 3 | Acrylic polyol 19 | SFI (10) | 15° C., catalyst 17 0.8% | 72 h |
| | | | (w/w) | |
| 4 | Aspartic ester | SFI (10) | 15° C., catalyst 17 0.8% | 12 h |
| | 20 | | (w/w) | |

In other embodiments, applicant has trialed single pack silane cure systems and hybrid systems. However initial focus has been trialing 2-pack systems of the type shown in the reaction sequences below which incorporate a secondary acrylic resin to improve cure speed and through-cure.

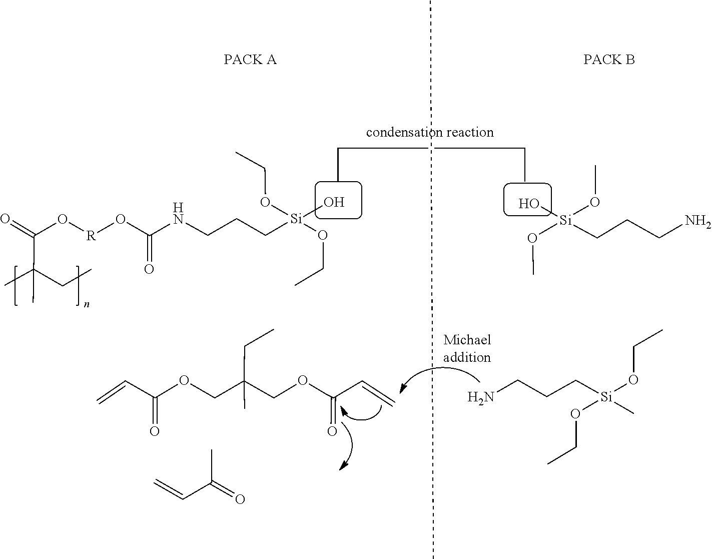

These resin systems are linked via the amino-silane compounds amino propyl trimethoxy silane (APTMS) and aminopropyl triethoxysilane (APTES) in pack B which creates a two-pack coating system.

Other types of formulation have been suggested by the applicant using the novel resins, such as creating a single-pack formulation as the resin is moisture-cure (see below). Further research would be on improving the cure rate and through-cure of the resin to enable a singular resin system required for single-pack systems.

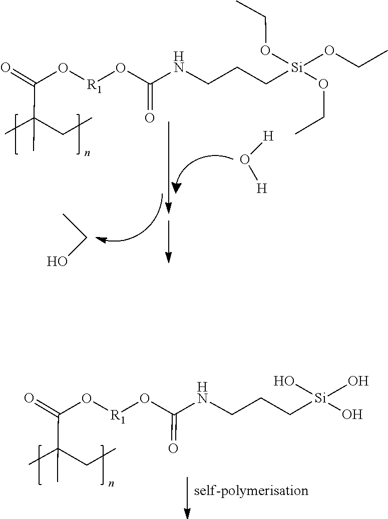

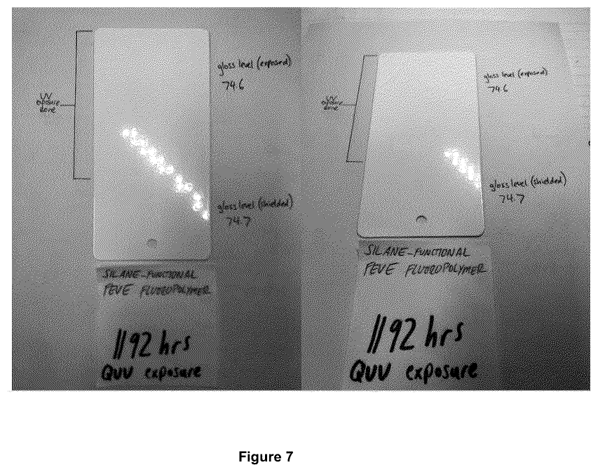

Novel formulations have been generated using the silane functional FEVE resin 11. The results (see FIG. 7) have shown a coating which has increased scratch resistance, and FEVE uv-resistance. FIG. 7 shows testing of the formulated silane-cure FEVE polyurethane (11) showing gloss retention after 1192 hours QUV exposure.

### Example—Comparison of Silane Modified Polyurethanes According to the Invention with Standard Polyurethanes in FTIR

Equipment used includes:
Shimadzu 8400s Fourier Transform Infrared Spectrometer
PIKE MIRacle single reflection ATR

Commercial isocyanates used for base isocyanate detection:
Edolan XCI aliphatic polyisocyanate (Tanatex chemicals)
Desmodur N3800 aliphatic polyisocyanate HDI trimer (Covestro)
Tolonate XF 800 aliphatic polyisocyanate HDI trimer (Vencorex)

Fourier Transform Infrared Spectroscopy (FT-IR) was used as a diagnostic tool for the detection of isocyanate (—NCO), carbonyl (—C═O—) and hydroxyl/amino (OH/NH) groups via measuring their infrared absorption and converting into a spectrum. The wavelengths absorbed or emitted are diagnostic for each functional group (table 3).

TABLE 3
Diagnostic absorption wavelengths of functional groups and
their spectral appearance on FT-IR.

| Functional | | Absorption | |
|---|---|---|---|
| group | Structure | (cm⁻¹) | Appearance |
| Isocyanate | N═C═O | 2250-2275 | Sharp, strong |
| Carbonyl | C═O | 1540-1870 | Sharp, medium to |
| | | | strong |
| Carbamate/ | —ONH—C═O | 1500-1600 | Broad, medium to |
| Urethane | | | string |
| Hydroxyl/ | —OH/—NH₂ | 3000-4000 | Broad, weak to |
| amino | | | medium |

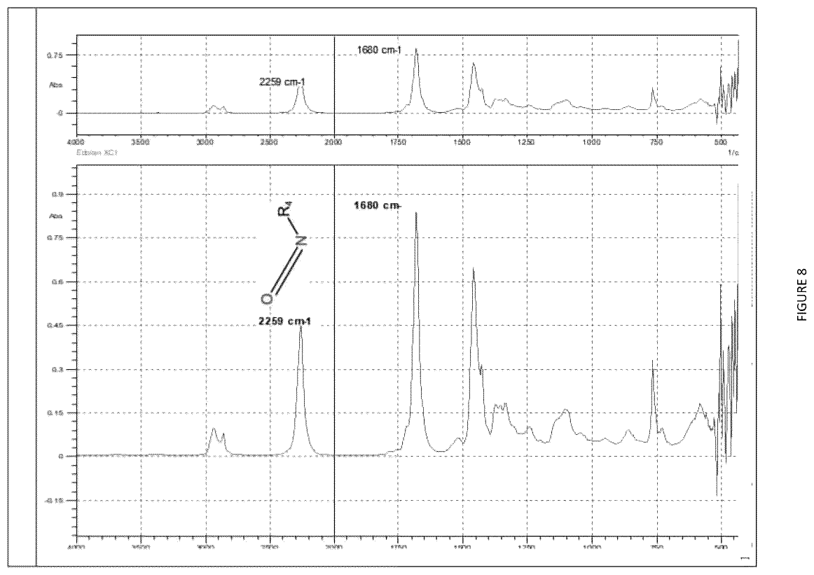

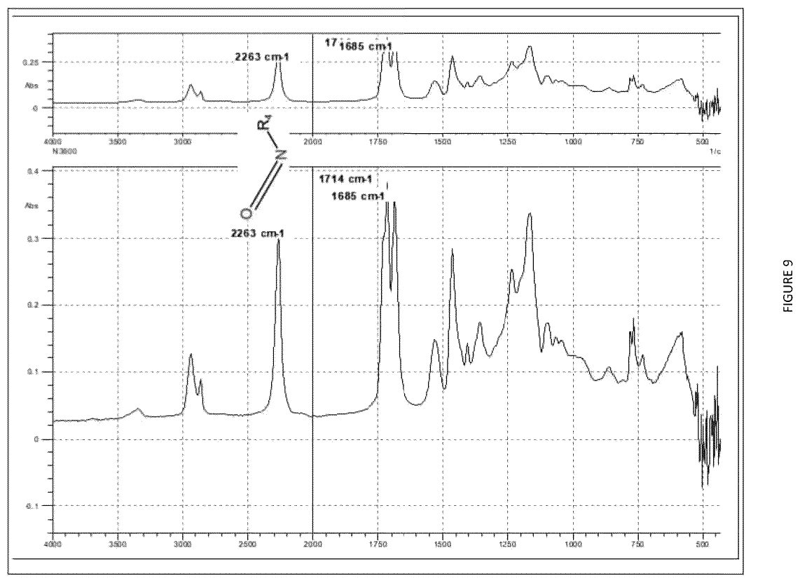

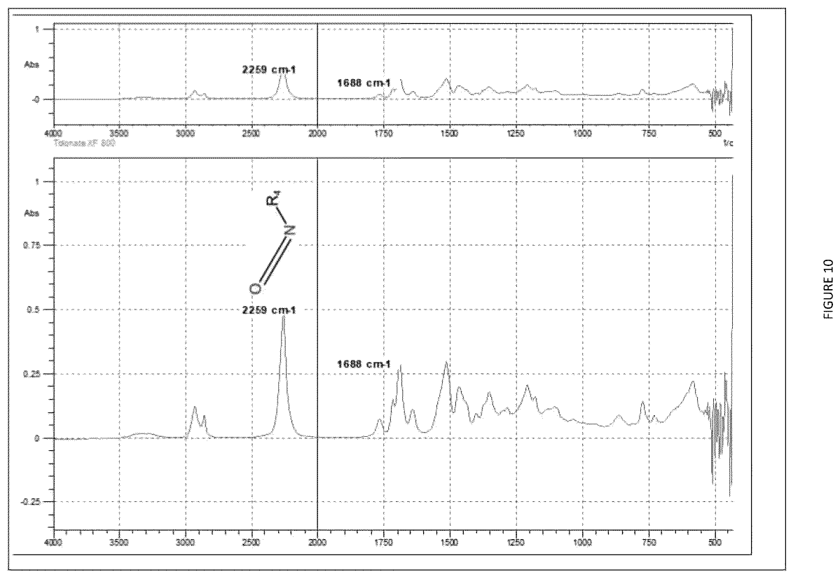

FIGS. 8 to 10 show the presence of isocyanate in the commercially available isocyanates via the characteristic IR absorbance. Table 4 shows analysis of isocyanate peaks of the commercial hardner resins with diagnostic peak being clearly visible in the relevant wavelength range.

TABLE 4
Summary of panel gloss levels on both the shielded and
non-shielded areas.

| | Commercial | Chemical | Isocyanate | Isocyanate |
|---|---|---|---|---|
| FIG. | name | structure | absorbance | peak |
| 1 | Edolan XCI | Aliphatic | 2259 cm⁻¹ | Strong, sharp |
| | | polyisocyanate | | |
| 2 | Desmodur | polyisocyanate HDI | 2263 cm⁻¹ | Strong, sharp |
| | N3800 | trimer | | |
| 3 | Tolonate XF | polyisocyanate HDI | 2259 cm⁻¹ | Strong, sharp |
| | 800 | trimer | | |

Reagents used for the silane modified polyurethane isocyanate-free resin C formation include:
Aliphatic acrylic polyol resin and/or FEVE resin A with hydroxyl functionality; and
Isocyanate B is 3-isocyanatopropyltriethoxy silane

Composition includes the following:
compound A being a FEVE polyol resin (Lumiflon LF-200) which is present in the formula between about 45-53% w/w solid resin;
compound B being 3-Isocyanatopropyltriethoxysilane present in the formula in an amount of between 10-23%;
xylene solvent for FEVE polyol resin present in an amount of between 30 to 35% w/w; and
catalyst Bismuth carboxylate (K-Kat 628), present in formula in an amount between 0.2 to 0.6% w/w

A silane functional polyurethane resin in accordance with the present invention is prepared by reacting FEVE polyol resin (Lumiflon LF-200) with 3-Isocyanatopropyltriethoxysilane in the presence of Bismuth carboxylate and the course of reaction tracked by FTIR to assess presence of unreacted or residual isocyanate.

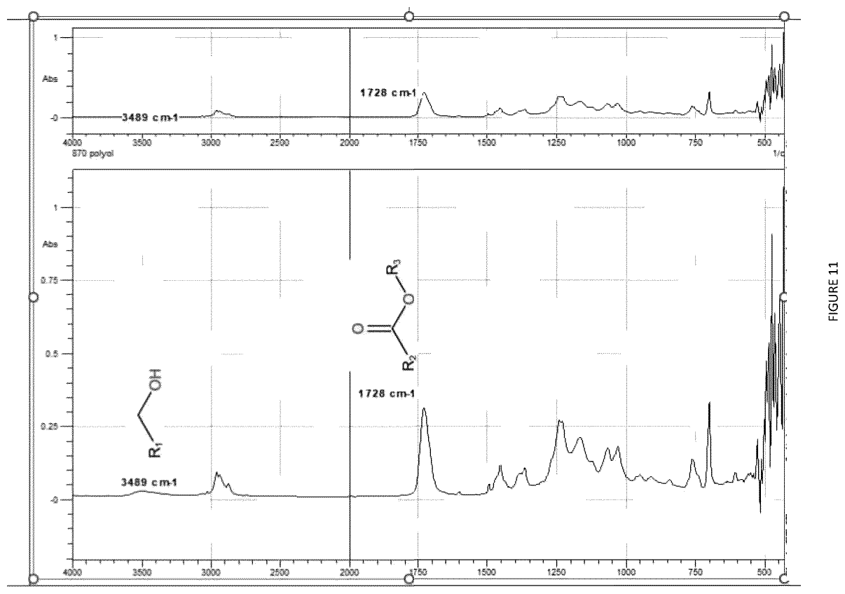

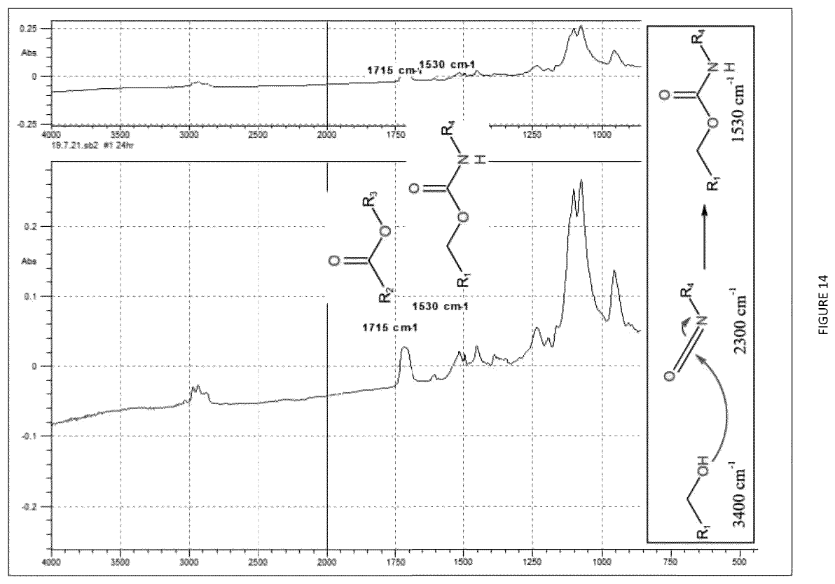

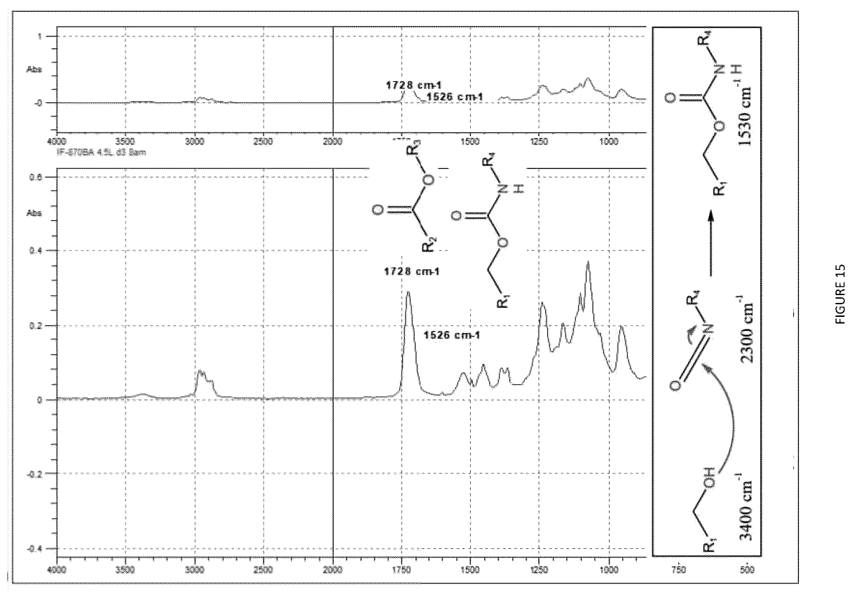

Referring to FIGS. 11 to 16, the production of the isocyanate-free polyurethane resin C was monitored via the Shimadzu 8400s Fourier Transform Infrared Spectrometer equipped with the PIKE MIRacle single reflection ATR. The reaction is shown as being completed with the consumption of the isocyanate peak at around 2300 cm⁻¹ and the formation of the carbamate absorbance at around 1530 cm⁻¹ (table 1).

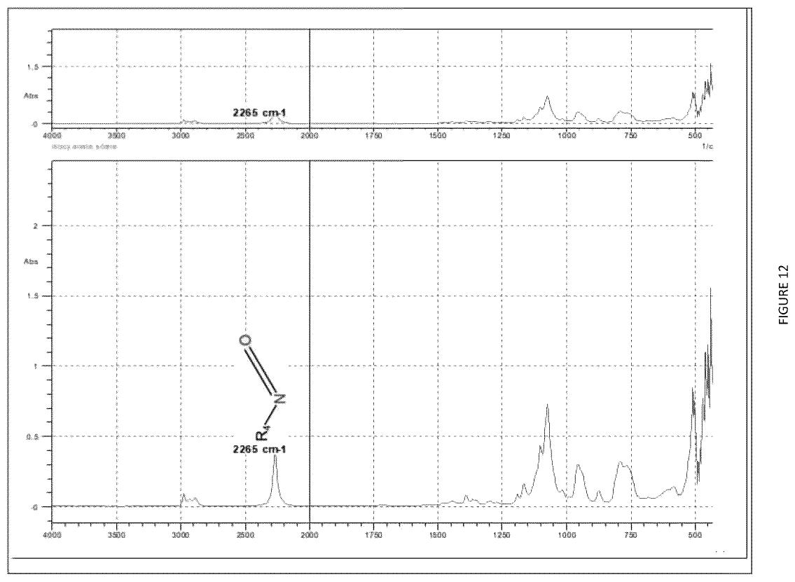

Analysis of the isocyanate B gave a strong, sharp peak at 2265 cm⁻¹. This absorbance peak was identified as the isocyanate group (FIG. 12).

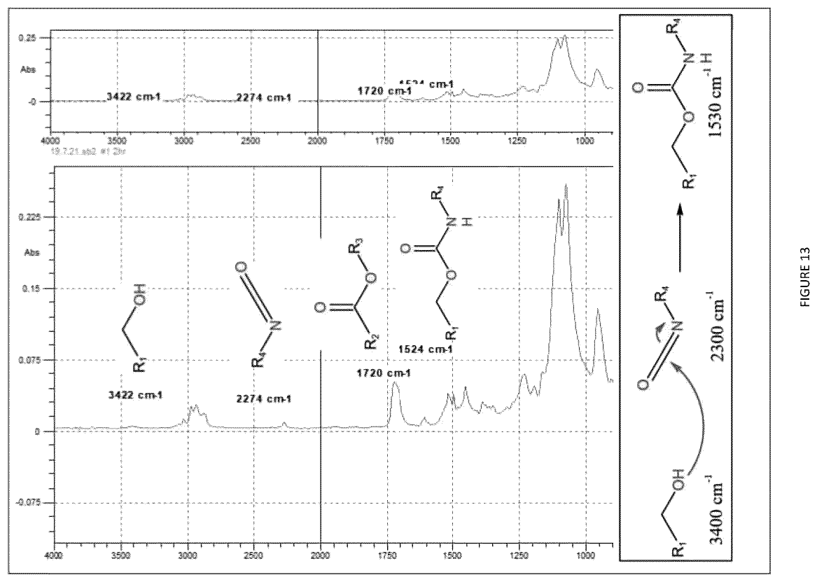

Analysis of the reaction mixture of A and B show the consumption of the isocyanate at 2300 cm-1, and the formation of the urethane at 1530 cm⁻¹ (FIGS. 13-15). After 24 hours the reaction was concluded to be complete due to the complete consumption of the isocyanate peak at 2300 cm⁻¹.

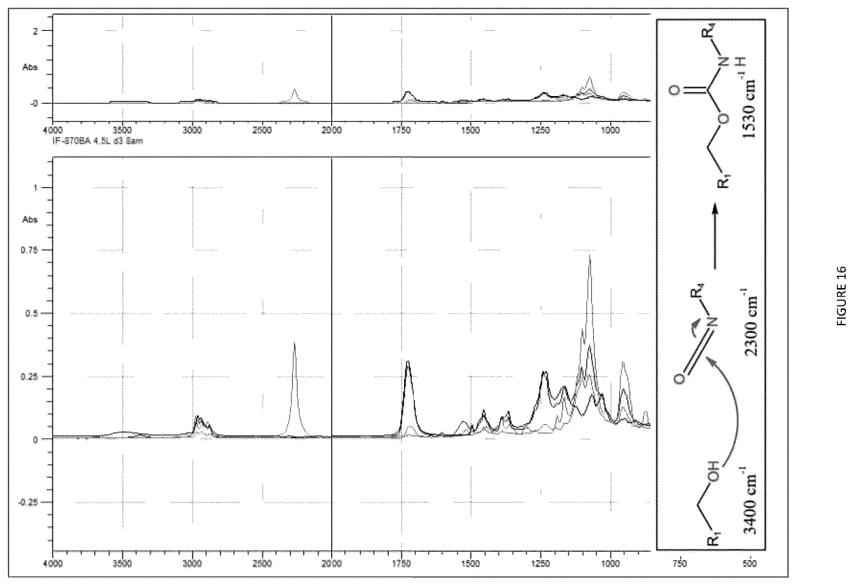

It was noted that absorbance at around 3500 cm⁻¹ was present in the final product, but was expected due to the component A being used in slight stoichiometric excess to aid in the complete removal of any trace isocyanate (FIG. 16)

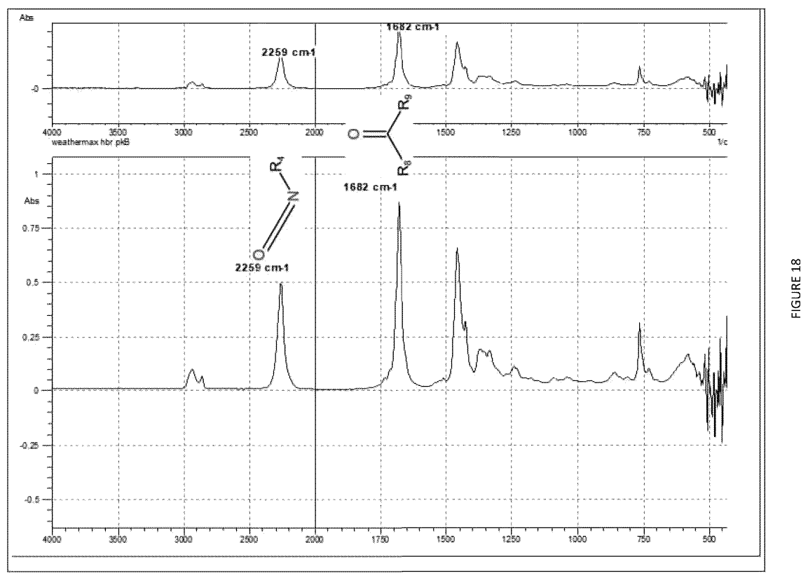

Analysis of the pack B of Weathermax HBR high build polyurethane gave a strong, sharp peak at 2259 cm⁻¹. This absorbance peak was identified as isocyanate, and shows the bulk of pack A to be composed of isocyanate (FIG. 18).

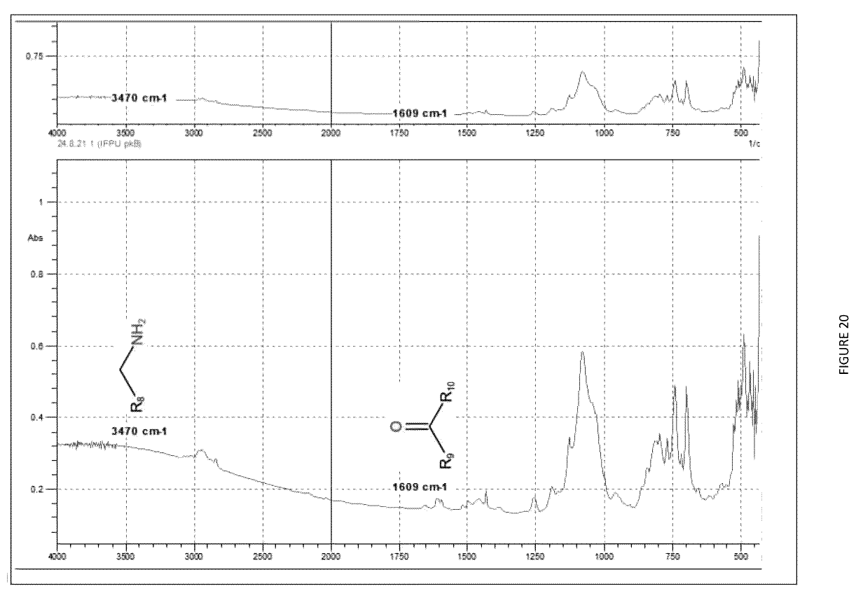

Analysis of the isocyanate-free polyurethane C gave a broad medium peak at 3470 cm⁻¹, and a weak, sharp peak at 1730 cm⁻¹. These absorbance peaks were identified as amine groups and ester carbonyl, respectively (FIG. 20).

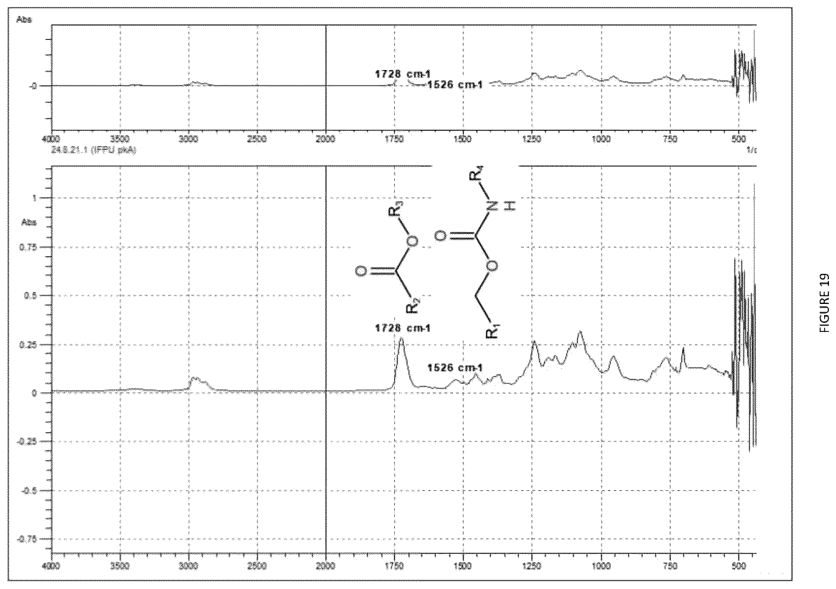

The presence of isocyanate in the commercially available Weathermax HBR coating composition was clear and unambiguous, with the sharp peak at around 2300 cm⁻¹ (FIG. 18). Analysis of the isocyanate-free polyurethane C shows no sign of an isocyanate, and indicates the presence of in-built carbamate/polyurethane functionality at 1530 cm⁻¹ (FIG. 19).

### Benefits

Minimizes and substantially eliminates unreacted isocyanates in producing silane functionalized FEVE resin;

A high conversion rate to the silane functionalized FEVE resin is achieved. As a result, toxic environmental exposure of an applicator to unreacted isocyanates is substantially eliminated;

The physical properties of the resulting silane functionalized FEVE resin retains properties of a polyurethane coating in addition to high UV resistance properties of a fluoropolymer.

Problems of prior art coating formulations requiring heating before application is overcome.

The resulting silane functionalized FEVE resin product improves adhesion to architectural material substrates hence reduced need for primer coats.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to a topcoat formulation and method of synthesizing a silane functionalized topcoat formulation to minimize isocyanate exposure and retain topcoat qualities of a polyurethane.

1-13. (canceled)

14. A formulation for preparing a high-performance polyurethane top coating effective to protect external surfaces and substantially minimizing applicator exposure to isocyanates, comprising: compound A chosen from a fluoroethylene vinyl ether (FEVE) moiety of formula (I): 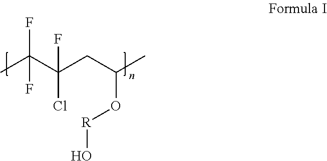
wherein
n is an integer higher than or equal to 1,
R is a linear or branched hydrocarbon chain, and
Compound B chosen from a silane functional isocyanate of general formula (II):

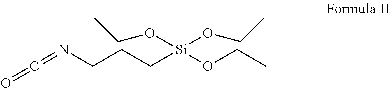

15. A curable isocyanate-free formulation of claim 14, wherein the formulation includes compound A and compound B present in a stoichiometric ratio of 1:1.

16. A curable isocyanate-free formulation of claim 14, wherein the formulation further includes a catalyst, compound C, effective to catalyse reaction between compound A and compound B at ambient temperature.

17. A curable isocyanate-free formulation of claim 14, wherein the catalyst is selected from the group consisting of: bismuth chelate, Aluminium chelate, Tin chelate, Zinc chelate, zinc complex, and base catalyst including 1,4-diazabicyclo[2.2.2]octane (DABCO). Preferably the catalyst is bismuth carboxylate.

18. A formulation for producing a silane functionalized FEVE resin as an improved top coat for architectural materials, comprising: compound A of formula (I) and compound B of formula (II) present in a stoichiometric ratio of 1:1; an effective catalytic amount of bismuth carboxylate; wherein compound A and compound B are reacted in the presence of the catalyst for a predetermined period of time at ambient temperature or above to produce the silane functionalized FEVE resin having substantially no unreacted isocyanate.

19. The formulation of claim 5, further comprising Compound D of formula (IV), wherein Compound D is an acrylic polyol which can be substituted for Compound A, which reacts with silane isocyanate cross linker Compound B.

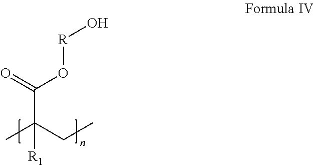

20. The formulation of claim 18 include Compound E of formula (V), wherein Compound E is an aspartic ester which can be substituted for Compound A, which reacts with silane isocyanate cross linker Compound B.

21. A method of preparing a high performance non-detectable isocyanate polyurethane top coating effective to protect external architectural surfaces and substantially minimizing applicator exposure to isocyanates, comprising:
providing an amount of compound A chosen from a fluoroethylene vinyl ether (FEVE) moiety of formula (I);
providing an amount of Compound B chosen from a silane functional isocyanate of general formula (II);
wherein the compound A and compound B are present in a stoichiometric ratio of 1:1;
providing an effective amount of a catalyst of compound C; and
introducing the compounds A and B into a reaction vessel and stirring the compounds in an inert atmosphere at a predetermined temperature and a predetermined time;
wherein the resultant silane functional FEVE resin is substantially free of unreacted isocyanate.

22. The method of claim 21, wherein the inert atmosphere is provided by nitrogen.

23. The method of claim 21, wherein the temperature of the reaction between compounds A and B in the presence of catalyst compound C is ambient temperature (15 degrees ° C.) to about 80 degrees ° C.

24. The method of claim 21, wherein the compounds A and B are stirred for between about 12 hours to 72 hours.

25. The method of claim 21, wherein the catalyst is bismuth carboxylate present in the reaction in an amount of between about 0.4% w/w to about 20% w/w.

26. A formulation for preparing a high-performance polyurethane top coating effective to protect external surfaces and substantially minimizing applicator exposure to isocyanates, comprising: compound A chosen from a fluoroethylene vinyl ether (FEVE) moiety of formula (I): 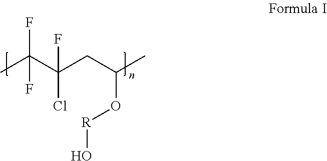
wherein
n is an integer higher than or equal to 1, in particular 1 to 10,
R is a linear or branched hydrocarbon chain, and
Compound B chosen from a silane functional isocyanate of general formula (II): 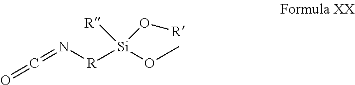
wherein
n is an integer higher than or equal to 1, in particular 1 to 10,
R and R′ is a linear or branched hydrocarbon chain, and
R″ is H, or OCH₃, OCH₂CH₃, or OR.
